(19) United States
(12) Patent Application Publication
(10) Pub. No.: US 2017/0137126 A1
(43) Pub. Date: May 18, 2017

(54) OBSTACLE AVOIDANCE SYSTEM FOR STABILIZED AERIAL VEHICLE AND METHOD OF CONTROLLING SAME

(71) Applicant: HER MAJESTY THE QUEEN IN RIGHT OF CANADA, AS REPRESENTED BY THE MINISTER OF NATIONAL DEFENCE, Ottawa (CA)

(72) Inventors: Franklin WONG, Quebec (CA); Pierre Richard BILODEAU, Quebec (CA)

(21) Appl. No.: 15/322,608

(22) PCT Filed: Jul. 16, 2014
(86) PCT No.: PCT/CA2014/050674

§ 371 Date: Dec. 28, 2016

(51) Int. Cl. B64C 39/02; G05D 1/04; G05B 6/02; G05D 1/10; G08G 5/04; G08G 5/00; G05D 1/08; G05D 1/00

(52) U.S. Cl. CPC B64C 39/024; G05D 1/0816; G05D 1/042; G05D 1/0088; G05D 1/101; G08G 5/045; G08G 5/0073; G05B 6/02; B64C 2201/146; B64C 2201/024; B64C 2201/127; B64C 2201/141

(57) ABSTRACT

An obstacle avoidance system for a stabilized aerial vehicle and a method of controlling same are provided. Using low angular resolution obstacle proximity data, such as from low angular resolution obstacle detection sensors, when a determination is made that an operator command to a vehicle propulsion system will result in a collision, the system overrides the operator command and substitutes an avoidance speed command and avoidance heading, while maintaining operator situational awareness, in a manner that is transparent to the operator. In an implementation, examination of objects requires the obstacle avoidance system to allow the vehicle to get close to obstacles. A human-portable aerial vehicle according to an implementation can be used for building surveillance, route inspection, surveillance of windows/hallways/rooftops, power distribution towers, pipelines, bridges, buildings or close examination of suspect objects.

### FIELD

The present disclosure relates to unmanned vehicles, including small stabilized aerial vehicles.

### BACKGROUND

Unmanned vehicles are used for different tasks and in different environments in which it is undesirable to have a person on board the vehicle, such as for reasons of safety. In some cases, unmanned vehicles are remotely controlled, or remotely piloted.

Stabilized unmanned vehicles, such as aerial vehicles, can be used to provide services including surveillance and inspection. While some unmanned vehicles are capable of entirely autonomous navigation, it is desirable in some surveillance implementations to permit an operator to perform remote control of the vehicle. Some implementations additionally provide mechanisms for obstacle avoidance. Existing approaches to unmanned vehicle control do not provide the desired combination of remote piloting and obstacle avoidance that prevents operator disorientation. Moreover, many approaches that are applied to unmanned ground vehicles cannot be applied to unmanned aerial vehicles and/or do not provide the same benefits or advantages due to their increased weight and power requirements.

Improvements in remotely-piloted aerial vehicles are desirable.

### BRIEF DESCRIPTION OF THE DRAWINGS

Embodiments of the present disclosure will now be described, by way of example only, with reference to the attached Figures.

FIG. 1 is a flowchart illustrating a navigation control method of a stabilized aerial vehicle according to an embodiment of the present disclosure.

FIG. 2 illustrates a system architecture for a sensor-equipped aerial vehicle according to an embodiment of the present disclosure.

FIG. 3 illustrates process and data relationships between an operator, an obstacle avoidance sub-system, a stabilization sub-system, a gimbaled onboard sensor and aerial vehicle motor controllers according to an embodiment of the present disclosure.

FIG. 4 illustrates navigation sensor data converted to a binary histogram according to an embodiment of the present disclosure.

FIG. 5 is a logical block diagram illustrating conversion of operator or avoidance heading command and operator or avoidance speed command into flight control commands according to an embodiment of the present disclosure.

FIG. 6 is a logical block diagram illustrating flight attitude and altitude controllers according to an embodiment of the present disclosure.

FIG. 7 is a graph illustrating attitude stabilization controller performance according to an embodiment of the present disclosure.

FIG. 8 is a graph illustrating translational speed controller performance according to an embodiment of the present disclosure.

FIG. 9 is a graph illustrating altitude controller performance according to an embodiment of the present disclosure.

FIG. 10 illustrates exemplary first experimental results of implementation of an obstacle avoidance sub-system according to an embodiment of the present disclosure.

FIG. 11 illustrates exemplary second experimental results of implementation of an obstacle avoidance sub-system according to an embodiment of the present disclosure.

### DETAILED DESCRIPTION

An obstacle avoidance system for a stabilized aerial vehicle and a method of controlling same are provided. Using low angular resolution obstacle proximity data, such as from low angular resolution obstacle detection sensors, when a determination is made that an operator command to a vehicle propulsion system will result in a collision, the system overrides the operator command and substitutes an avoidance speed command and avoidance heading, while maintaining operator situational awareness in a manner that is transparent to the operator. In an implementation, examination of objects requires the obstacle avoidance system to allow the vehicle to get close to obstacles yet remain at a safe stand-off distance. A human-portable aerial vehicle according to an implementation can be used for building surveillance, route inspection, surveillance of windows/hallways/rooftops, power distribution towers, pipelines, bridges, buildings or close examination of suspect objects. Implementations described herein allow the operator to focus on understanding data from the sensors on the vehicle, rather than focus on keeping the vehicle from colliding with objects.

In an embodiment, the present disclosure provides a method of controlling a stabilized aerial vehicle, comprising: generating an angular position look-up vector based on sensed low angular resolution obstacle proximity data and on gap angle data associated with gaps between obstacles, the angular position look-up vector comprising a set of safe headings; comparing a received heading command with the set of safe headings; if the received heading command is outside of the set of safe headings, replacing the received heading command with a proportional avoidance heading within the set of safe headings while maintaining operator situational awareness, generating an avoidance speed proportional to a vehicle-to-obstacle distance, and passing the proportional avoidance heading to a vehicle control sub-system; if the received heading command is within the set of safe headings, passing the operator command unaltered to the vehicle control sub-system; controlling the stabilized aerial vehicle based on the received heading command when the received heading command is within the set of safe headings, and controlling the stabilized aerial vehicle based on the avoidance heading and on the avoidance speed, when the received heading command is outside of the set of safe headings, such that the vehicle is enabled to perform collisionless examination of nearby obstacles while maintaining a close yet safe hovering distance from the nearby obstacles.

In an example embodiment, the low angular resolution obstacle proximity data is sensed by one or more low angular resolution obstacle detection sensors configured to sense obstacle proximity in low angular resolution sectors.

In an example embodiment, the set of safe headings in the angular position look-up vector are computed based on a vehicle safety distance.

In an example embodiment, the method further comprises calculating the proportional avoidance speed based on the avoidance heading and on the sensed obstacle proximity data.

In an example embodiment, the method further comprises calculating the proportional avoidance heading command based on the avoidance heading parameter and obstacle map data.

In an example embodiment, generating the angular position look-up vector comprises determining an angular position of gaps between obstacles that are large enough to permit the vehicle to pass through without collision.

In an example embodiment, the method further comprises evaluating the avoidance heading to ensure that the avoidance heading steers the vehicle away from obstacles if the vehicle enters into a pre-defined active zone containing obstacles.

In an example embodiment, the avoidance heading is generated according to a Smooth Nearness-Diagram (SND) method.

In an example embodiment, the generated avoidance speed is within a range from 0.35*Vmax to Vmax, where Vmax is a maximum speed of the vehicle.

In an example embodiment, generating the angular position look-up vector and controlling the vehicle are performed on the vehicle.

In another embodiment, the present disclosure provides an obstacle avoidance system for a stabilized aerial vehicle, the system comprising: one or more low angular resolution obstacle detection sensors configured to sense low angular resolution obstacle proximity data; a processor; and a memory. The memory stores statements and instructions for execution by the processor to: generate an angular position look-up vector based on sensed low angular resolution obstacle proximity data and on gap angle data associated with gaps between obstacles, the angular position look-up vector comprising a set of safe headings; compare a received heading command with the set of safe headings; if the received heading command is outside of the set of safe headings, replace the received heading command with a proportional avoidance heading within the set of safe headings while maintaining operator situational awareness, generate an avoidance speed proportional to a vehicle-to-obstacle distance, and pass the proportional avoidance heading to a vehicle control sub-system; if the received heading command is within the set of safe headings, pass the operator command unaltered to the vehicle control sub-system; control the stabilized aerial vehicle based on the received heading command when the received heading command is within the set of safe headings, and control the stabilized aerial vehicle based on the avoidance heading and on the avoidance speed, when the received heading command is outside of the set of safe headings, such that the vehicle is enabled to perform collisionless examination of nearby obstacles while maintaining a close yet safe hovering distance from the nearby obstacles.

In an example embodiment, the one or more low angular resolution obstacle detection sensors comprise one or more lightweight acoustic sensors.

In an example embodiment, the one or more low angular resolution obstacle detection sensors comprise one or more scanning laser range finder navigation sensors.

In an example embodiment, the one or more low angular resolution obstacle detection sensors are configured to sense obstacle proximity in low angular resolution sectors.

In a further embodiment, the present disclosure provides a remotely-piloted stabilized human-portable aerial vehicle, comprising: a propulsion system; a gimbaled sensor; an attitude stabilization system; and an obstacle avoidance system. The obstacle avoidance system includes: one or more low angular resolution obstacle detection sensors configured to sense low angular resolution obstacle proximity data; a processor; and a memory storing statements and instructions for execution by the processor to: generate an angular position look-up vector based on sensed low angular resolution obstacle proximity data and on gap angle data associated with gaps between obstacles, the angular position look-up vector comprising a set of safe headings; compare a received heading command with the set of safe headings; if the received heading command is outside of the set of safe headings, replace the received heading command with a proportional avoidance heading within the set of safe headings while maintaining operator situational awareness, generate an avoidance speed proportional to a vehicle-to-obstacle distance, and pass the proportional avoidance heading to a vehicle control sub-system; if the received heading command is within the set of safe headings, pass the operator command unaltered to the vehicle control sub-system; control the stabilized aerial vehicle based on the received heading command when the received heading command is within the set of safe headings, and control the stabilized aerial vehicle based on the avoidance heading and on the avoidance speed, when the received heading command is outside of the set of safe headings, such that the vehicle is enabled to perform collisionless examination of nearby obstacles while maintaining a close yet safe hovering distance from the nearby obstacles.

In an example embodiment, the one or more low angular resolution obstacle detection sensors are configured to sense obstacle proximity in low angular resolution sectors.

In an example embodiment, the vehicle comprises a fixed-pitch multi-rotor stabilized human-portable aerial vehicle.

In an example embodiment, the aerial vehicle further comprises a mixer configured to combine attitude and altitude commands with the avoidance heading and the avoidance speed.

In an example embodiment, the vehicle has a weight of less than 3 kg.

In an example embodiment, the vehicle has dimensions less than 100 cm×100 cm×30 cm high in its deployed state.

Other aspects and features of the present disclosure will become apparent to those ordinarily skilled in the art upon review of the following description of specific embodiments in conjunction with the accompanying figures.

In fully manual flight, an operator makes all decisions and suffers all related consequences. In fully autonomous flight, the machine makes all decisions and suffers related consequences in terms of unforeseen circumstances, etc. Embodiments of the present disclosure combine benefits of both manual flight and autonomous flight, in a way that does not cause confusion to the operator and maintains situational awareness.

In many existing obstacle avoidance approaches, high resolution navigation sensors are employed to provide high accuracy for obstacle detection, to ensure detection of small objects. However, such approaches employ expensive and heavy weight sensors; such industrial-grade components are not suitable for use in a lightweight vehicle as they would prevent proper operation by limiting flight time and increasing weight while adding cost. Embodiments of the present disclosure employ low resolution sensors to sense obstacle proximity in angular sectors to detect larger objects while using components that are more weight and power efficient so that a lightweight aerial vehicle can maintain a desired flight time.

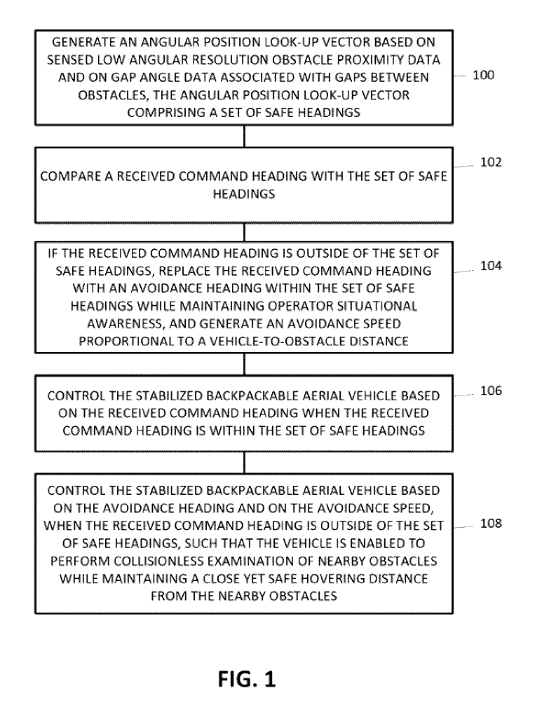

FIG. 1 is a flowchart illustrating a navigation control method of a stabilized human-portable aerial vehicle according to an embodiment of the present disclosure. As shown in FIG. 1, the method includes step 100 of generating an angular position look-up vector based on sensed low angular resolution obstacle proximity data and on gap angle data associated with gaps between obstacles, the angular position look-up vector comprising a set of safe headings. The sensed low angular resolution obstacle proximity data is sensed by one or more low angular resolution obstacle detection sensors configured to sense obstacle proximity in angular sectors. This is in contrast to high resolution obstacle detection sensors that provide a high degree of accuracy.

Embodiments of the present disclosure generate or determine speed and heading commands based upon an angular position look-up vector, in contrast to known approaches that generate an avoidance speed command based on a turn rate command that is inversely proportional to the distance between the vehicle and the obstacle. According to embodiments of the present disclosure, obstacle gaps and proximity to obstacles are determined and the vehicle is allowed to maintain a safe distance from the obstacle to allow observation. This is in contrast to known approaches which track the path of moving objects and avoidance commands guide the vehicle away from the moving object. Moreover, embodiments of the present disclosure determine obstacle avoidance commands, or obstacle avoidance commands, based upon the present location of objects, in contrast to known approaches which determine obstacle avoidance commands based upon a prediction of where the obstacle will be in the future. Additionally, while some known approaches only detect obstacles, embodiments of the present disclosure detect the angle of safe gaps as well as obstacles.

At 100, in an example embodiment, gap analysis over an active zone creates the angular position look up-vector identifying angular positions that meet a minimum gap width. In an embodiment, if the operator commands a heading that corresponds to an angular position meeting the minimum gap width, the vehicle is allowed to proceed; otherwise, the operator command is seamlessly overridden and an avoidance heading is generated, for example according to the Smooth Nearness-Diagram (SND) method. In an example embodiment, the avoidance speed command is within a range from 0.35 vₘₐₓ to vₘₐₓ, where vₘₐₓ is the maximum speed of the vehicle. The closer an object to the vehicle, the lower the value of the avoidance speed command.

At 102, a received heading command is compared with the set of safe headings. In an example embodiment, the received heading command is a steering command. As shown at 104, if the received heading command is outside of the set of safe headings, the received heading command is replaced with a proportional avoidance heading within the set of safe headings while maintaining operator situational awareness. In an example embodiment, the replacement of the received heading command with the proportional avoidance heading is performed seamlessly and transparently with respect to the operator. An avoidance speed is generated, proportional to a vehicle-to-obstacle distance, and the proportional avoidance heading is passed to a vehicle control sub-system. In an example embodiment, the proportional avoidance heading comprises a measured, smooth continuous response to a perturbation.

If the received heading command is within the set of safe headings, the operator command is passed unaltered to the vehicle control sub-system. As shown at 106, the stabilized human-portable aerial vehicle is controlled based on the received heading command when the received heading command is within the set of safe headings.

As shown at 108, the stabilized human-portable aerial vehicle is controlled, in an embodiment seamlessly and transparently with respect to the operator, based on the avoidance heading and on the avoidance speed, when the received heading command is outside of the set of safe headings, such that the vehicle is enabled to perform collisionless examination of nearby obstacles while maintaining a close yet safe hovering distance from the nearby obstacles.

While some known approaches for ground vehicles provide control based on avoidance headings, such approaches do not provide stabilization using flightweight and power efficient devices, and the vehicles are neither human-portable nor aerial. As such, such approaches do not enable a vehicle to perform collisionless examination of nearby obstacles while maintaining a close yet safe hovering distance from the nearby obstacles.

Also, in contrast to approaches which use non-smooth additive alteration to the operator command, such as based on boxes formulated around objects, embodiments of the present disclosure generate new continuous speed and heading commands based upon obstacle gaps and proximity to obstacles and control the vehicle based on these newly generated values.

While other approaches determine a dangerous area and take action to avoid obstacles (e.g. a corner) within the dangerous area, embodiments of the present disclosure allow vehicle travel into gaps if the width between obstacles is large enough and the vehicle is allowed to hover near obstacles. Embodiments of the present disclosure also allow a vehicle to proceed at a speed and heading decided by the operator, if a gap is wider than a predetermined amount, instead of overriding the operator-defined speed causing operator disorientation.

With respect to 108, according to example embodiments of the present disclosure, in relation to airborne obstacle avoidance or obstacle avoidance, operator commands are seamlessly overridden based upon the angular position look-up vector such that a collision will not occur, whilst allowing the vehicle to maintain a safe distance from the obstacle to allow examination of an obstacle. The commands from the operator are compared with the angular position look-up vector and a command override only occurs when the command would result in the likelihood of a collision. A command override generates avoidance speed and heading commands that maintain situational awareness, for example by smoothly transitioning from the operator command.

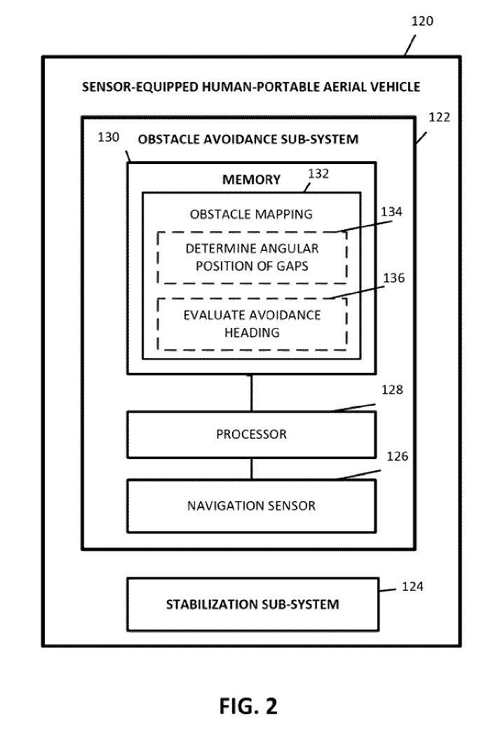

FIG. 2 illustrates a system architecture for a sensor-equipped human-portable aerial vehicle 120 according to an embodiment of the present disclosure, including an obstacle avoidance sub-system 122 and a stabilization sub-system 124. In an example embodiment, the lightweight obstacle avoidance sub-system 122 is integrated into a flight-stabilized back-packable, fixed-pitch multi-rotor aerial vehicle. The obstacle avoidance system 122 comprises a navigation sensor 126 and a daughter processor 128 and memory 130 which cooperate to execute an obstacle mapping and navigation method according to an embodiment of the present disclosure.

In an embodiment, the navigation sensor 126 comprises one or more low angular resolution obstacle detection sensors configured to sense obstacle proximity in angular sectors, and configured to provide low angular resolution obstacle proximity data. In an example embodiment, the one or more low resolution obstacle detection sensors have an angular resolution of about 15 degrees, as opposed to a resolution of about 1 degree of a high resolution sensor. In an example embodiment, the one or more low resolution obstacle detection sensors are distance measuring devices. In another example embodiment, the one or more low angular resolution obstacle detection sensors comprise one or more lightweight acoustic sensors. In a further example embodiment, the one or more low angular resolution obstacle detection sensors comprise one or mare scanning laser range finder navigation sensors.

The navigation sensor 126 measures distances and angular positions of objects relative to the aerial vehicle's coordinate system. The data is analyzed by an obstacle mapping function, or obstacle mapping method, 132 to determine an avoidance heading parameter. If the operator unknowingly commands the vehicle to move towards some obstacles, the obstacle mapping function, or navigation function, 132 calculates: a smooth transitional avoidance speed command based on the obstacle distance; and a smooth transitional avoidance heading command based on the avoidance heading parameter and obstacle map data. The avoidance speed and heading are transmitted to the flight controller and supersede the operator command, in a manner that maintains operator situational awareness, for example which is seamless and transparent to the operator. Once the vehicle has moved past the obstacles, control is relinquished seamlessly and transparently back to the operator.

In an example embodiment, the obstacle mapping function 132 comprises two functions. A first function, or gap determination function, 134 determines the angular position of gaps between any obstacles that are large enough to let the vehicle pass through without any possibility of a collision. A second function, or avoidance heading evaluation function, 136 evaluates the avoidance heading that steers the vehicle away from any obstacles if the vehicle enters into a pre-defined active zone that contains obstacles.

In an example embodiment, the present disclosure provides a lightweight sensor-equipped aerial vehicle (SAV) that autonomously reacts and avoids unexpected obstacles while maintaining stable attitude and altitude flight all without operator intervention.

In an embodiment, the processing and override capabilities are on the vehicle itself. The vehicle comprises a propulsion system, a gimbaled sensor, obstacle detection sensors, an obstacle avoidance system and an attitude stabilization system.

In an example implementation, the attitude and altitude commands are combined with the motor commands through a mixer matrix.

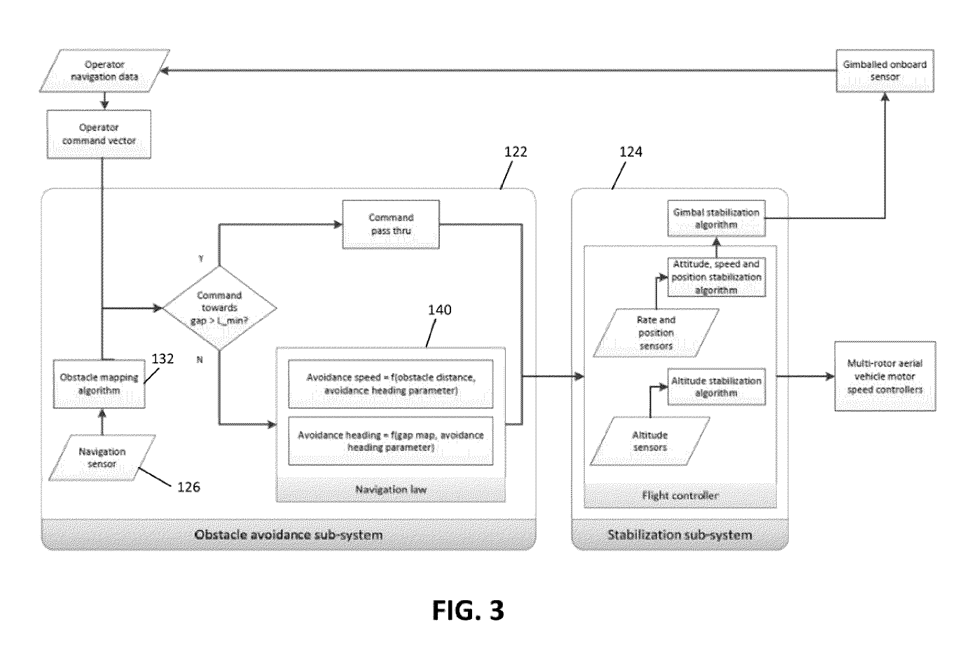

FIG. 3 illustrates process and data relationships between an operator, an obstacle avoidance sub-system, a stabilization sub-system, a gimbaled onboard sensor and aerial vehicle motor controllers according to an embodiment of the present disclosure. In FIG. 3, the parallelograms represent data inputs while the rectangles represent processes.

As shown in FIG. 3, the obstacle avoidance sub-system 122 comprises one or more navigation sensors 126. The navigation sensors 126 measure range, Dᵢ, and angular position, θᵢ, data of obstacle, i, within its angular coverage, θ_{coverage}. The performance of the navigation sensors 126 is characterized by their angular resolution, θᵣₑₛ, minimum and maximum range, Dₘᵢₙ and Dₘₐₓ, and refresh rate. For scanning type sensors, the total number of individual data points, M, is determined by

$$M = int [ \frac{{θ}_{coverage}}{{θ}_{res}} ] \qquad ( 1 )$$

As indicated and described above with respect to FIG. 2, the obstacle mapping function 132 as shown in FIG. 3 comprises a gap determination function and an avoidance heading evaluation function. The gap determination function calculates the angular position of gaps of suitable width for the vehicle to pass using the data from the navigation sensor. The sensor configuration outputs an integer number of readings at angular position, θᵢ, up to a maximum of M readings per scan. Each reading has an associated angular resolution θᵣₑₛ.

In an example embodiment, the gap analysis is carried out over a circular active zone with a radius, R_{active}, defined by

R_{active}=k₁(R+Dₛ) (1)

where k₁ is a user-defined constant 1<k₁<4, R is the vehicle radius (m) and Dₛ is a user-defined safety distance (m).

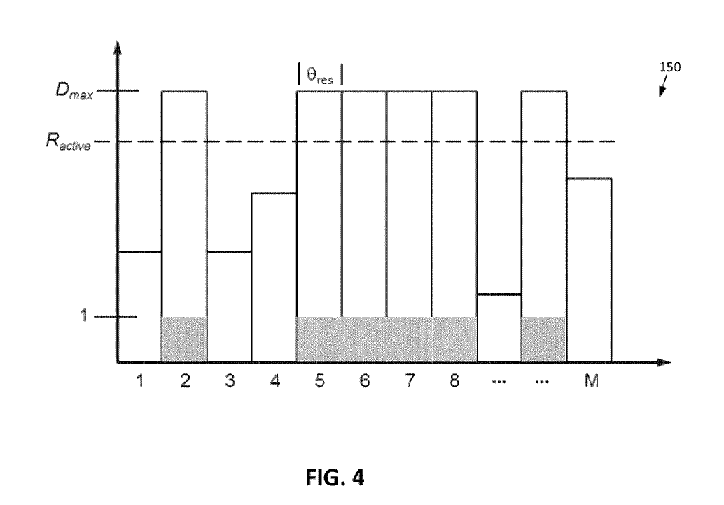

In an embodiment, a binary histogram 150 as shown in FIG. 4 is created from the sensor configuration scan. The histogram values are determined by

Bᵢ=1 if (Dᵢ−R_{active})>0

Bᵢ=0 if (Dᵢ−R_{active})<0 (2)

where i=1 to M, M is the maximum readings, Bᵢ is the binary value at 1, Dᵢ is the distance to obstacle i (m). FIG. 4 illustrates diagrammatically the operation.

In an example embodiment, the minimum gap width, Lₘᵢₙ, is defined as

Lₘᵢₙ=2k₂(R+Dₛ) (3)

where k₂ is a user defined constant 1<k₂<1.2.

In an embodiment, a look-up vector is created to identify the angular positions that have a gap meeting the minimum gap width criteria. The total number of elements in the look-up vector equals the maximum number of readings M from the sensor configuration.

In an example embodiment, the binary values in the look-up vector elements, Lᵢ for i=1 to M are calculated according to

$$\begin{matrix}{L}_{i} = 1 & if ( {m}_{hi} - {m}_{lo} ) {R}_{active} {θ}_{res} > {L}_{min} \\ {L}_{i} = 0 & otherwise\end{matrix} \qquad ( 4 )$$

where mₕᵢ=j when Bᵢ transitions from 1 to 0 at j-jₕᵢ for j=1 to M, and mᵢₒ=j when Bᵢ transitions from 0 to 1 at j+jᵢₒ for j=1 to M, under the condition that Bᵢ=1 between mₕᵢ and mᵢₒ.

In an embodiment, the values of jᵢₒ and jₕᵢ are calculated by

$$\begin{matrix}{j}_{lo} = int [ - {L}_{min} / ( 2 {R}_{active} {θ}_{res} ) ] \\ {j}_{hi} = - {j}_{lo}\end{matrix} \qquad ( 5 )$$

In an embodiment, the heading command, θ_{cmd}, passed to a navigation function, or navigation method, 140 is continuously filtered according to the value of Lₖ

θ_{cmd}=operator command if Lₖ=1 at θ^{d}

θ_{cmd}=f(avoidance) if Lₖ=0 at θ^{d} (6)

where θ^{d} is the angular heading commanded by the operator, and k=int [M(θ^{d}−θᵣₑₛ)/2π]+1.

In an example embodiment, the navigation method 140 is part of a seamless and continuous mixing method according to an embodiment of the present disclosure. Referring back to FIG. 3, the mixing method comprises the element 140 as well as the functions starting from the decision point of ‘Command towards gap >L_min’ and ending in the command going into the Flight Controller. The mixing method comprises commands that are generated if the vehicle is heading towards a gap >L_min and commands that are generated if it is headed towards a gap <L_min. As shown in FIG. 3, when gap >L_min, no alteration of the operator command vector is needed in order to avoid decoupling the vehicle from the operator control and causing human-machine disorientation. When gap <L_min, according to an embodiment of the present disclosure seamless and automated intervention is provided only to the extent that smoothing functions be used for the avoidance speed and avoidance heading commands, for the purpose of avoiding human-machine disorientation. According to an embodiment of the present disclosure, smoothing functions are used for avoidance and speed.

The second function, or avoidance heading evaluation function f(avoidance), is based on the Smooth Nearness-Diagram (SND) method, some details of which are provided herein for completeness.

The SND method evaluates the threat level associated with each of the N obstacles that are detected and measured within the vehicle active zone, R_{active}, (eq. 1). The strength of the obstacle, sᵢ, is calculated by

$${s}_{i} = {sat}_{[ 0 , 1 ]} ( \frac{{D}_{s} + R - {D}_{i}}{{D}_{s}} ) \qquad ( 7 )$$

where Dₛ is the safety distance (m), R is the vehicle radius (m) and Dᵢ is the measured obstacle distance. Note that the safety zone around the vehicle, R_{safety}, is defined as a circular zone with a radius

R_{safety}=Dₛ+R (8)

Equation 7 states that sᵢ saturates to 1 when an obstacle is within the vehicle's safety zone. Otherwise it is zero when no obstacles are in the safety zone.

The individual avoidance angle, δᵢ, for each obstacle, nᵢ, is calculated by

δᵢ=sᵢ proj(dist_{cc}((θᵢ+π),θ^{d}))ε[−π,π[ (9)

where sᵢ is the obstacle strength, proj( . . . ) is the counter-clockwise angle between the obstacle angular position, θᵢ, and the desired heading, θ^{d}. If the vehicle is touching obstacle nᵢ, δᵢ corresponds to a heading 180 degrees away from the obstacle direction no matter what the operator heading command, θ^{d}, may be at the time.

With each discrete avoidance angle, the vehicle avoidance heading, Δ_{avoid}, is calculated by

$${Δ}_{avoid} = {\sum }_{i = 1}^{N} \frac{{s}_{i}^{2}}{{s}_{tot}} {δ}_{i} ε [ - π , π [ \qquad ( 10 )$$

where N is the total number of obstacles detected and sₜₒₜ is defined as

sₜₒₜ=Σᵢ₌₁^{N}sᵢ² (11)

The avoidance heading command, θₜᵣₐⱼ, transmitted to the navigation function 140 is

θ^{traj}=θ^{d}+Δ_{avoid} (12)

The heading command accounts for the presence of obstacles in the vehicle's active zone.

Referring back to FIG. 3, the navigation function 140 is illustrated. A fixed-pitch multi-rotor aerial vehicle is a non-holonomic platform and is not subject to the kinematic limitations typically found in ground vehicles. The navigation function 140 according to an embodiment of the present disclosure comprises a heading and a speed command.

The avoidance heading command was given above in Equation 12.

The avoidance speed command, v_{T}, is

$${v}_{T} = {sat}_{[ 0 , 1 ]} ( \frac{{D}_{min}^{obst} - R}{{D}_{s}} ) {v}_{max} \qquad ( 13 )$$

where D^{obst}ₘᵢₙ is min (D₁ . . . D_{N}) and vₘₐₓ is the maximum speed of the vehicle. Equation 13 states that vₜₒₜ saturates to Vₘₐₓ when there are no obstacles within the safety zone. A minimum speed of 0*vₘₐₓ has been selected to ensure that the vehicle stops in tightly grouped obstacles.

Table 1 below provides details regarding an example embodiment with respect to the sensors employed in an obstacle avoidance sub-system according to an embodiment of the present disclosure. Table 1 provides details of sensors and their characteristics from two different sensor configurations. The first configuration comprises a circular array of eight sonar units to obtain 360 degree coverage. The second configuration comprises one scanning laser range finder combined with two sonar units to obtain 360 degree coverage.

TABLE 1
Navigation sensor characteristics

| | Range | Angular | Angular | Refresh | |
|---|---|---|---|---|---|
| | [min max] | coverage | resolution | rate | Weight |
| Sensor | (m) | (deg) | (deg) | (Hz) | (g) |
| Scanning laser | [0.1 30] | 270 | 0.25 | 40 | 370 |
| range finder | | | | | |
| Hokuyo | | | | | |
| UTM30LX | | | | | |
| Sonar | [0.15 7.65] | 45 | 45 | 10 | 15 |
| XL-MaxSonar- | | | | | |
| EZ MB1200 | | | | | |

In an example implementation, the Gumstix Overo Tide computer-on-module was selected to run the obstacle avoidance methods. This component is based around a Texas Instruments OMAP3530 Applications Processor running at 720 MHz, and comes with 512 MB of RAM and a SD card reader for OS and data storing. To access processor functionalities, the Tobi expansion board was employed. The Tobi board provides access to Ethernet, USB Host, a 40 pin expansion port to access processor pins (DART, SPI, I2C, ADC, and GPIOs) for sensor input to the microprocessor and navigation command output to the flight controller.

The Angstrom Linux distribution runs on the Overo as the principal operation system. The distribution was obtained by compiling source code with the cross-compilation environment Open Embedded. The Gumstix wiki describes how to setup this environment. Building scripts were modified to obtain a minimalistic Linux image capable of real-time execution.

Player network server software 3.0.2 was used to manage data communications between the navigation sensors, the obstacle avoidance algorithms and the flight controller commands. The parameters used in the obstacle map and navigation algorithms were: Robot radius, R: 0.7 m; Safety distance, Dₛ: 1.3 m; Constant for active radius, k₁: 3; Constant for minimum gap width, k₂: 1; and Max speed, vₘₐₓ: 1.0 m/s.

Referring back to FIG. 3, the attitude control method employed in the stabilization sub-system 124 can be any suitable attitude control method. A summary of a particular controller architecture employed with embodiments of the present disclosure is provided herein for completeness.

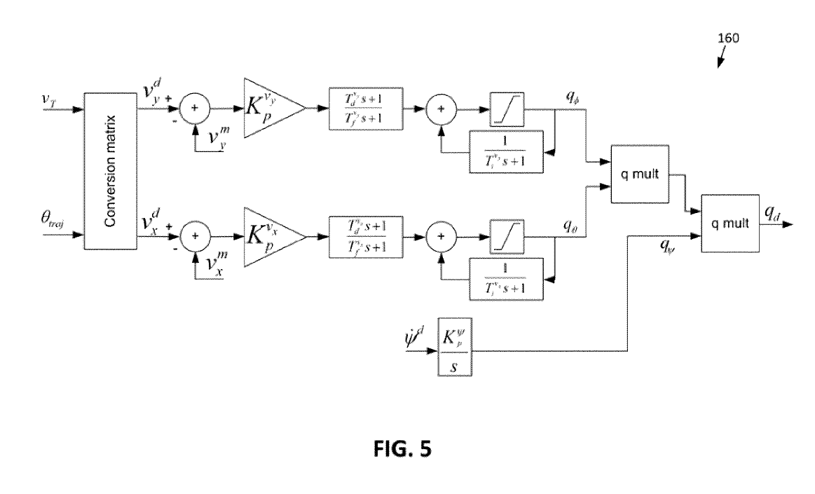

FIG. 5 is a logical block diagram 160 illustrating conversion of operator or avoidance heading command and operator or avoidance speed command into velocity component commands according to an embodiment of the present disclosure. FIG. 5 shows the avoidance heading command θₜᵣₐⱼ and the avoidance speed command v_{cmd} are converted into velocity component commands, v^{d}ₓ and v^{d}_{y}, in the inertial reference frame. In an embodiment, a Proportional-Integral-Derivative (PID) anti-windup speed controller is employed to prevent controller saturation and to calculate an angular position command in terms of a command quaternion q_{d} that will allow the system to respect the commanded heading and speed setpoints.

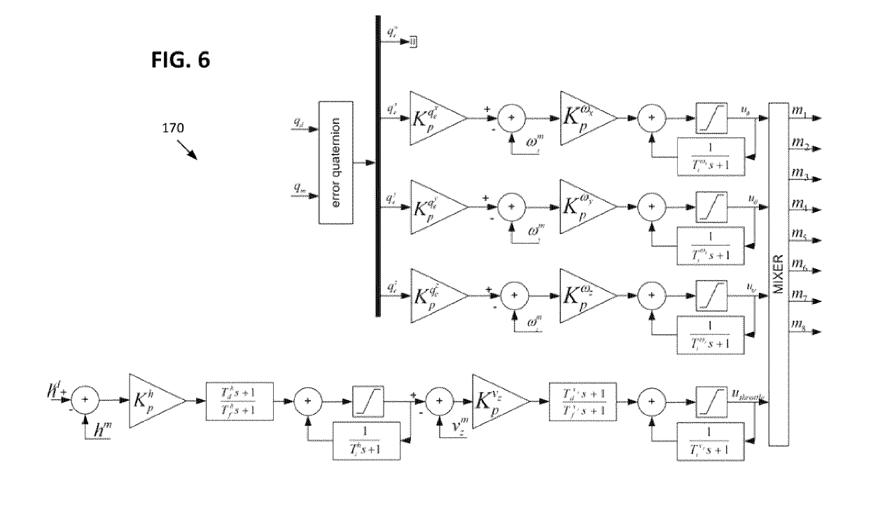

FIG. 6 is a logical block diagram 170 illustrating flight attitude and altitude controllers according to an embodiment of the present disclosure. The command quaternion q_{d} is compared to the measured vehicle quaternion qₘ in FIG. 6. The error signal qₑ is decomposed into its components q^{x}ₑ, q^{y}ₑ and q^{x}ₑ. A Proportional-Derivative (PD) controller is cascaded with a PID anti-windup angular rate controller to calculate the angular rate commands, u_{φ}, u_{θ} and u_{ν}. The angular rates commands are converted to individual motor commands, mᵢ, through a mixer matrix.

The altitude control architecture is shown in FIG. 6. PID anti-windup controllers for altitude, h, and vertical speed, v_{z}, are cascaded to calculate the throttle command, uₜₕᵣₒₜₜₗₑ, that maintains altitude stability.

Controller gains are provided below in Table 2.

TABLE 2
Attitude and altitude controller gains

| | | | | | | | | | | | | | |
|---|---|---|---|---|---|---|---|---|---|---|---|---|---|
| Kₚ^{v}^{ₓ} | −0.245 | Kₚ^{v}^{_{y}} | 0.245 | Kₚ^{v}^{_{z}} | −275 | Kₚ^{q}^{ₑ}^{^{x}} | 10 | Kₚ^{q}^{ₑ}^{^{y}} | 10 | Kₚ^{q}^{ₑ}^{^{z}} | 8 | Kₚ^{h} | −0.65 |
| Tᵢ^{v}^{ₓ} | 10.0 | Tᵢ^{v}^{_{y}} | 10.0 | Tᵢ^{v}^{_{z}} | 1.0 | Kₚ^{w}^{ₓ} | 90 | Kₚ^{w}^{_{y}} | 90 | Kₚ^{w}^{_{z}} | 300 | Tᵢ^{h} | 10 |
| T_{d}^{v}^{ₓ} | 0.1 | T_{d}^{v}^{_{y}} | 0.1 | T_{d}^{v}^{_{z}} | 0.05 | Tᵢ^{w}^{ₓ} | 2 | Tᵢ^{w}^{_{y}} | 2 | Tᵢ^{w}^{_{z}} | 2 | T_{d}^{h} | 2.0 |
| T_{f}^{v}^{ₓ} | 0.05 | T_{f}^{v}^{_{y}} | 0.05 | T_{f}^{v}^{_{z}} | 0.04 | — | — | — | — | — | — | T_{f}^{h} | 1.5 |

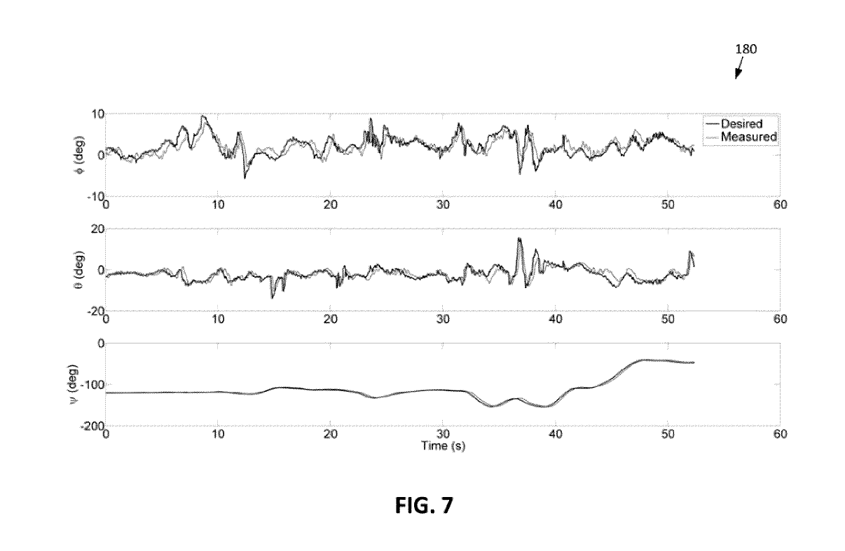

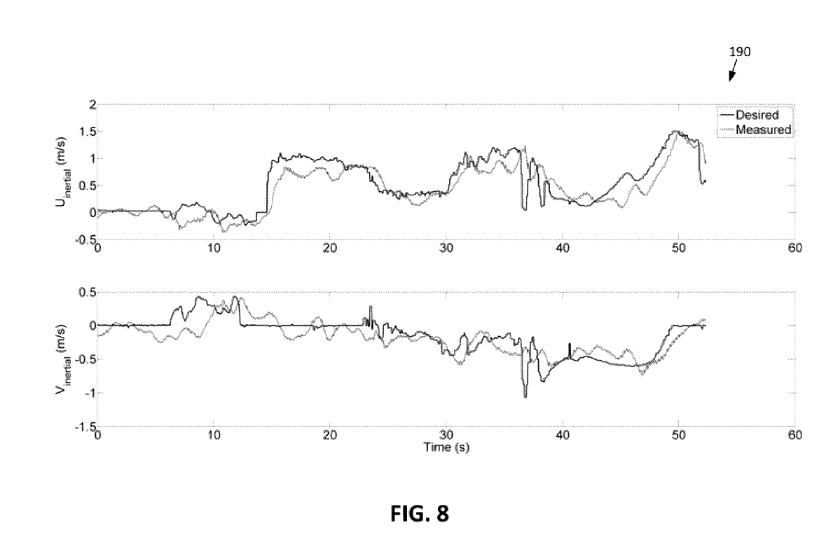

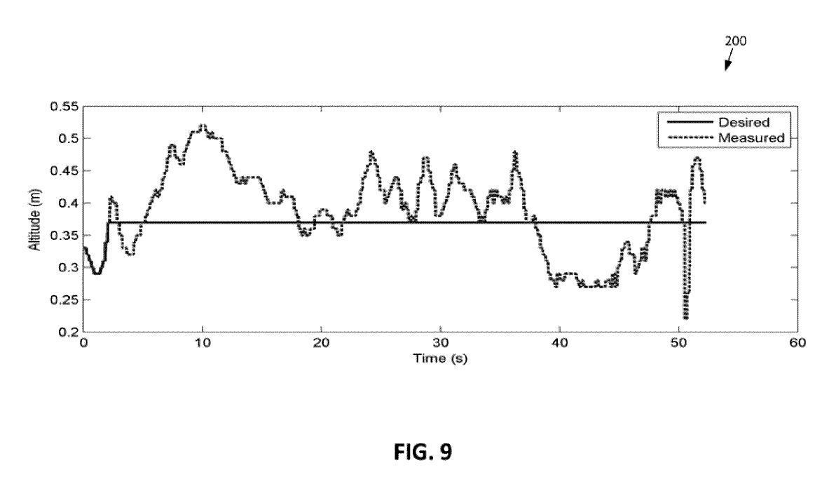

The performance of the controller in terms of attitude stability, translational speed and vertical speed controllability are shown in the graphs 180, 190 and 200 of FIGS. 7, 8 and 9, respectively.

In an example embodiment, the control methods in FIGS. 5 and 6 are compiled and implemented in the flight controller with the WinAVR development environment and the software patched needed for the selected flight controller.

In an example embodiment, a fixed-pitch multi-rotor aerial vehicle possesses the characteristics identified in Table 3. Both generic and specific parameters have been provided. The specific parameters apply to the SAV according to an example embodiment of the present disclosure.

TABLE 3
Fixed-Pitch Multi-Rotor Aerial Vehicle Characteristics

| | |
|---|---|
| Generic Description or | Specific Component or |
| Characteristic | Characteristic |

Aerial Vehicle Components

| | | |
|---|---|---|
| Flight controller | Measures vehicle attitude | Mikrokopter Flight-Ctrl v2.1 |
| | using a six-axis inertial | programmed with the flight |
| | measurement unit and vehicle | stabilization algorithms |
| | speed, position and heading | described in Sec. 3, SBG IG- |
| | with an absolute reference | 500N attitude heading |
| | sensor. Computes motor | reference system |
| | commands with onboard | |
| | microprocessor programmed | |
| | with flight stabilization | |
| | algorithms to automatically | |
| | maintain stable flight. | |
| | Measures altitude using a | |
| | barometric pressure and range | |
| | finder and computes motor | |
| | commands to automatically | |
| | maintain a desired altitude. | |
| Obstacle Avoidance sub- | Measures distance from | Gumstix Overo-based |
| system | vehicle to surrounding | daughter board running |
| | obstacles, determines if vehicle | coupled with either a Hokuyo |
| | can safely pass through or by | scanning laser range finder |
| | obstacles and seamlessly and | or a Maxbotix sonar array. |
| | continuously generates vehicle | |
| | control commands to avoid the | |
| | obstacles or allows the | |
| | operator control over the | |
| | vehicle flight path. | |
| Power distribution | Accepts the motor commands | Mikrokopter Okto XL power |
| controller | from the flight controller and | distribution board v8 |
| | generates appropriate control | |
| | signal to power circuit to rotate | |
| | individual propellers at the | |
| | desired angular speed. | |
| Propulsion sub-system | Comprised of electronic speed | Eight sets of Mikrokopter BL- |
| | controller, motor and propeller. | Ctrl v2.0, Robbe ROXXY |
| | Between 3 to 8 motors may be | 2827-35 brushless motor and |
| | mounted individually or in pairs | EPP 1045 CF propeller |
| | on the airframe. | |
| Sensor and sensor | Comprised of a roll-tilt gimbal | Mikrokopter HiSight III, Iftron |
| stabilization sub-system | driven by stabilization | high resolution CCD camera, |
| | commands from the flight | Mondo Stinger 5.8 GHz 500 mW |
| | controller. Gimbal supports a | video transmitter, |
| | lightweight sensor to transmit | YellowJacket 5.8 Pro |
| | data to the operator for | Diversity receiver, EVG920 |
| | situational awareness. | video eyewear |
| Airframe | Comprised of lightweight | Mikrokopter Okto XL frame |
| | central core structure to hold | set |
| | flight controller, camera | |
| | stabilization sub-system, power | |
| | distribution controller and | |
| | power source. Propulsion units | |
| | supported by 3 to 8 metallic or | |
| | composite material arms that | |
| | are attached to the central | |
| | core. | |
| Power source | Lithium-ion or lithium polymer | Two Thunder Power 5000 mAh |
| | batteries. | 4-cell 25C lithium |
| | | polymer batteries |
| Remote pilot sub-system | Comprised of a transmitter to | Graupner MX-20 transmitter |
| | communicate operator | and Graupner GR-24 |
| | trajectory or function | receiver |
| | commands and an onboard | |
| | receiver to pass the operator | |
| | commands to the flight | |
| | controller. | |

Aerial Vehicle Characteristics

| | | |
|---|---|---|
| Gross weight of SAV | 1.0-1.5 kg | 1.5 kg |
| without power source and | | |
| self-navigation sub-system | | |
| Payload capacity required | 1.0-2.0 kg | 1.5 kg |
| for power source and self- | | |
| navigation sub-system | | |
| Flight Range | 100-3000 m | 1000 m |
| Flight Speeds | Translation: 0-10 m/s | Translation: 0-2 m/s |
| | Rotation: 0-200 deg/s | Rotation: 0-100 deg/s |
| Flight endurance | 10-60 minutes | 20 minutes |

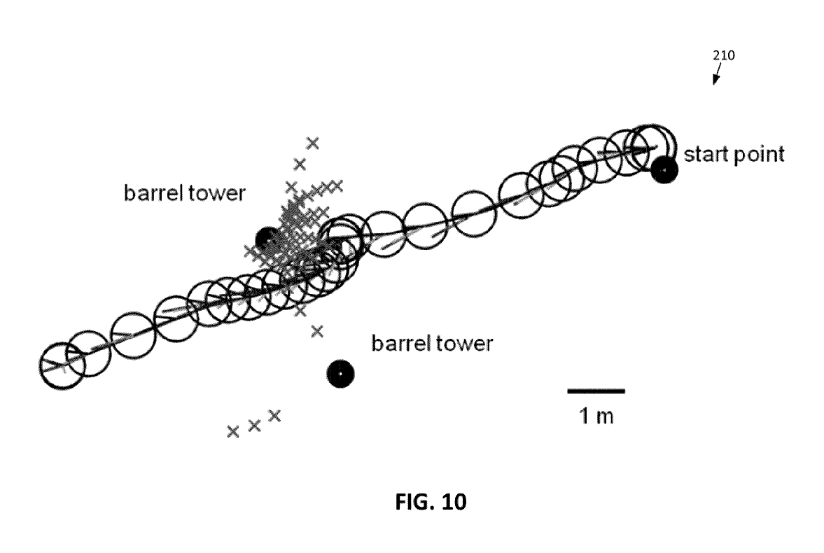

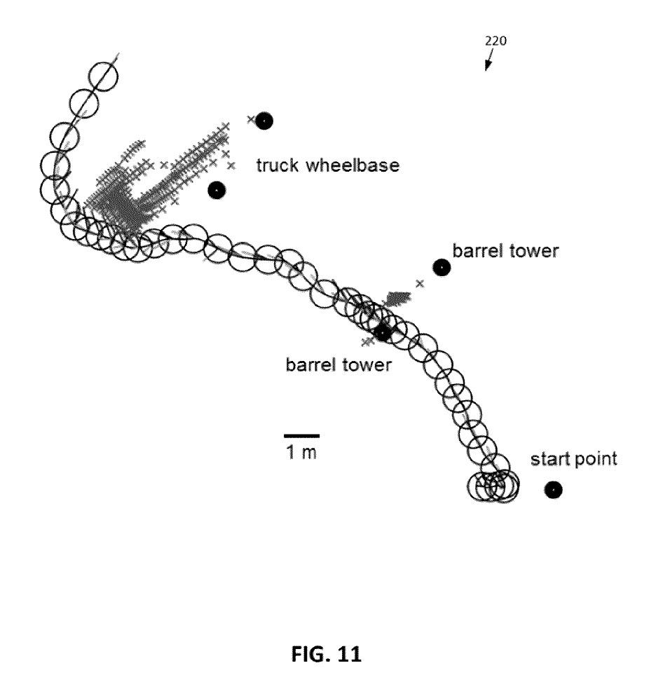

FIGS. 10 and 11 illustrate exemplary first and second experimental results, respectively, of implementation of an obstacle avoidance sub-system according to an embodiment of the present disclosure.

In both experiments, the obstacles consisted of two barrel towers and a commercial pickup truck with a cab over the flatbed. In these examples, each barrel tower measured 0.8 m diameter×2 m high. The two towers were spaced 3 m apart. The truck measured 2 m wide×5 m long and was parked 10 m downstream from the barrel towers.

In each test run, the operator lifted the vehicle off the ground 10 m upstream of the barrel towers. After activating the attitude and altitude stabilization control loops and the obstacle avoidance sub-system, the operator guided the vehicle towards a target point using visual data from the stabilized onboard camera. As the vehicle approached an obstacle, the operator purposely gave navigation commands that would have forced a collision between the vehicle and obstacle in order to test the robustness of the obstacle avoidance sub-system. The test ended after the vehicle reached the designated target point.

FIG. 10 shows the results 210 of the test run for a sensor-equipped aerial vehicle (SAV) configured with a sonar array. The black solid circles denote starting point or the two barrel towers. The black open circles denote the aerial vehicle earth-referenced position. The ‘x’ denotes range and angular position of detected obstacles. The darker straight lines denote operator heading command. The lighter straight lines denote avoidance heading command.

It can be seen in FIG. 10 that the SAV increased forward speed after lifting off from the starting point by the longer spacings between the black open circles. As it approached the right side barrel tower, the obstacle was detected and its range and angular position relative to the SAV was measured. The obstacle measurements, i.e. the x's, are concentrated around the right side barrel tower. The operator tried to guide the SAV towards the barrel tower as evidenced by the direction of the blue lines towards the tower. The obstacle mapping and navigation law algorithms generated avoidance speed and heading commands that autonomously slowed the forward speed of the SAV and put it on a heading away from the obstacle. These commands superseded the operator command thus preventing the SAV from colliding with the obstacle. Once the obstacle was cleared, control was returned seamlessly back to the operator as the SAV proceeded to the target point downstream from the barrel towers.

FIG. 11 shows the results 220 of the test run for a sensor-equipped aerial vehicle (SAV) configured with a scanning laser range finder. The black solid circles denote starting point, the two barrel towers or the truck wheelbase. The black open circles denote the aerial vehicle earth-referenced position. Each ‘x’ denotes range and angular position of detected obstacles. The darker straight lines denote operator heading command. The lighter straight lines denote avoidance heading command.

The data in FIG. 11 shows that the SAV increased forward speed after lifting off from the starting point by the longer spacings between the black open circles. As it approached the left side barrel tower, the left and right side obstacles were detected and their ranges and angular positions relative to the SAV were measured. The operator steered the SAV into the barrel tower gap as evidenced by the heading direction indicated by the blue lines. No avoidance speed and heading commands were generated as evidenced by the green lines. After passing the barrel towers, the SAV was directed towards the truck. The obstacle mapping and navigation law algorithms generated avoidance speed and heading commands that autonomously slowed the forward speed of the SAV and put it on a heading away from the truck cab. The outline of the truck body and truck cab can be seen from the scanning laser range finder data, i.e. the x's. The obstacle avoidance commands superseded the operator command thus preventing the SAV from colliding with the truck. Once the truck body was cleared, control was returned seamlessly back to the operator as the SAV proceeded to the target point downstream from the truck.

Embodiments of the present disclosure provide a remotely-piloted multi-rotor stabilized aerial vehicle with obstacle avoidance capability. In an example embodiment, the vehicle is back-packable, meaning that it is shaped and constructed to fit within a person's backpack; accordingly, the obstacle avoidance and stabilization system must be lightweight.

In an example embodiment, a human-portable system can be quantified by one or more of the following characteristics: a) weight less than 3 kg; b) dimensions less than 100 cm×100 cm×30 cm high in its deployed state; or c) dimensions less than 70 cm×50 cm×20 cm high in its stored state.

An aerial vehicle according to an embodiment of the present disclosure monitors obstacles and gaps in the environment using, for example, sonar or laser sensors. When the vehicle determines that an operator command to the vehicle propulsion system will result in a collision, the vehicle seamlessly overrides the operator command and continuously substitutes an avoidance speed command and avoidance heading. In an implementation, examination of objects requires the obstacle avoidance system to allow the vehicle to get close to obstacles.

Embodiments of the present disclosure provide one or more of the following features and advantages: seamless and continuous transition between operator control and machine control; operator command pass thru; and smoothing functions for vehicle speed and heading in the presence of obstacles.

An aerial vehicle according to an embodiment of the present disclosure can be used for building surveillance, route inspection, surveillance of windows/hallways/rooftops, power distribution towers, pipelines, bridges, buildings or close examination of suspect objects. Sensors such as infra-red sensors or video cameras can be mounted n the vehicle to provide data to the operator. Slow hovering and obstacle avoidance are desirable features for this type of vehicle. At distances greater than 10 m the vehicle operator loses depth perception and without obstacle avoidance, collisions are highly likely. Embodiments of the present disclosure allow the operator to focus on understanding data from the sensors on the vehicle, rather than focus on keeping the vehicle from colliding with objects.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (als referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (C-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method of controlling a stabilized aerial vehicle, comprising:
generating an angular position look-up vector based on sensed low angular resolution obstacle proximity data and on gap angle data associated with gaps between obstacles, the angular position look-up vector comprising a set of safe headings;
comparing a received heading command with the set of safe headings;
if the received heading command is outside of the set of safe headings, replacing the received heading command with a proportional avoidance heading within the set of safe headings while maintaining operator situational awareness, generating an avoidance speed proportional to a vehicle-to-obstacle distance, and passing the proportional avoidance heading to a vehicle control sub-system;
if the received heading command is within the set of safe headings, passing the operator command unaltered to the vehicle control sub-system;
controlling the stabilized aerial vehicle based on the received heading command when the received heading command is within the set of safe headings, and
controlling the stabilized aerial vehicle based on the avoidance heading and on the avoidance speed, when the received heading command is outside of the set of safe headings, such that the vehicle is enabled to perform collisionless examination of nearby obstacles while maintaining a close yet safe hovering distance from the nearby obstacles.

2. The method of claim 1 wherein the low angular resolution obstacle proximity data is sensed by one or more low angular resolution obstacle detection sensors configured to sense obstacle proximity in low angular resolution sectors.

3. The method of claim 1 wherein the set of safe headings in the angular position look-up vector are computed based on a vehicle safety distance.

4. The method of claim 1 further comprising calculating the proportional avoidance speed based on the avoidance heading and on the sensed obstacle proximity data.

5. The method of claim 1 further comprising calculating the proportional avoidance heading command based on the avoidance heading parameter and obstacle map data.

6. The method of claim 1 wherein generating the angular position look-up vector comprises determining an angular position of gaps between obstacles that are large enough to permit the vehicle to pass through without collision.

7. The method of claim 1 further comprising evaluating the avoidance heading to ensure that the avoidance heading steers the vehicle away from obstacles if the vehicle enters into a pre-defined active zone containing obstacles.

8. The method of claim 1 wherein the avoidance heading is generated according to a Smooth Nearness-Diagram (SND) method.

9. The method of claim 1 wherein the generated avoidance speed is within a range from 0.35*Vmax to Vmax, where Vmax is a maximum speed of the vehicle.

10. The method of claim 1 wherein generating the angular position look-up vector and controlling the vehicle are performed on the vehicle.

11. An obstacle avoidance system for a stabilized aerial vehicle, the system comprising:
one or more low angular resolution obstacle detection sensors configured to sense low angular resolution obstacle proximity data;
a processor; and
a memory storing statements and instructions for execution by the processor to:
generate an angular position look-up vector based on sensed low angular resolution obstacle proximity data and on gap angle data associated with gaps between obstacles, the angular position look-up vector comprising a set of safe headings;
compare a received heading command with the set of safe headings;
if the received heading command is outside of the set of safe headings, replace the received heading command with a proportional avoidance heading within the set of safe headings while maintaining operator situational awareness, generate an avoidance speed proportional to a vehicle-to-obstacle distance, and pass the proportional avoidance heading to a vehicle control sub-system;
if the received heading command is within the set of safe headings, pass the operator command unaltered to the vehicle control sub-system;
control the stabilized aerial vehicle based on the received heading command when the received heading command is within the set of safe headings, and
control the stabilized aerial vehicle based on the avoidance heading and on the avoidance speed, when the received heading command is outside of the set of safe headings, such that the vehicle is enabled to perform collisionless examination of nearby obstacles while maintaining a close yet safe hovering distance from the nearby obstacles.

12. The system of claim 11 wherein the one or more low angular resolution obstacle detection sensors comprise one or more lightweight acoustic sensors.

13. The system of claim 11 wherein the one or more low angular resolution obstacle detection sensors comprise one or more scanning laser range finder navigation sensors.

14. The system of claim 11 wherein the one or more low angular resolution obstacle detection sensors are configured to sense obstacle proximity in low angular resolution sectors.

15. A remotely-piloted stabilized human-portable aerial vehicle, comprising:
a propulsion system;
a gimbaled sensor;
an attitude stabilization system; and
an obstacle avoidance system, the obstacle avoidance system including:
one or more low angular resolution obstacle detection sensors configured to sense low angular resolution obstacle proximity data;
a processor; and
a memory storing statements and instructions for execution by the processor to:
generate an angular position look-up vector based on sensed low angular resolution obstacle proximity data and on gap angle data associated with gaps between obstacles, the angular position look-up vector comprising a set of safe headings;
compare a received heading command with the set of safe headings;
if the received heading command is outside of the set of safe headings, replace the received heading command with a proportional avoidance heading within the set of safe headings while maintaining perator situational awareness, generate an avoidance speed proportional to a vehicle-to-obstacle distance, and pass the proportional avoidance heading to a vehicle control sub-system;
if the received heading command is within the set of safe headings, pass the operator command unaltered to the vehicle control sub-system;
control the stabilized aerial vehicle based on the received heading command when the received heading command is within the set of safe headings, and
control the stabilized aerial vehicle based on the avoidance heading and on the avoidance speed, when the received heading command is outside of the set of safe headings, such that the vehicle is enabled to perform collisionless examination of nearby obstacles while maintaining a close yet safe hovering distance from the nearby obstacles.

16. The aerial vehicle of claim 15 wherein the one or more low angular resolution obstacle detection sensors are configured to sense obstacle proximity in low angular resolution sectors.

17. The aerial vehicle of claim 15 wherein the vehicle comprises a fixed-pitch multi-rotor stabilized human-portable aerial vehicle.

18. The aerial vehicle of claim 15 further comprising a mixer configured to combine attitude and altitude commands with the avoidance heading and the avoidance speed.

19. The aerial vehicle of claim 15 wherein the vehicle has a weight of less than 3 kg.

20. The aerial vehicle of claim 15 wherein the vehicle has dimensions less than 100 cm×100 cm×30 cm high in its deployed state.
